(19) United States
(12) Patent Application Publication
(10) Pub. No.: US 2026/0327019 A1
(43) Pub. Date: Oct. 22, 2026

(54) Crossbelt Sorter

(71) Applicant: Interroll Holding AG, Sant' Antonino (CH)

(72) Inventors: Thomas Eisinger, Hückelhoven (DE); Florian Funk, Hückelhoven (DE)

(21) Appl. No.: 19/113,916

(22) PCT Filed: Sep. 25, 2023
(86) PCT No.: PCT/EP2023/076325

§ 371 Date: Mar. 21, 2025

(30) Foreign Application Priority Data
Sep. 28, 2022 (EP) 22198525.2

(51) Int. Cl. B65G 47/46; B65G 47/96

(52) U.S. Cl. CPC B65G 47/46; B65G 47/96; B65G 2201/02

(57) ABSTRACT

Crossbelt sorter (1), adapted to sort an object (9) into one of a plurality of discharge stations (14). The crossbelt sorter (1) comprises a plurality of crossbelt carts (11); the crossbelt carts (11) are movable along a conveying direction (R) on a circumferentially closed conveying track (13). The crossbelt cart (11) comprises a crossbelt (12), wherein the crossbelt (12) provides a conveying surface for supporting an object (9) to be conveyed. The crossbelt (12) is moveable relative to the crossbelt cart (11) in a traverse direction (Q) traverse to the conveying direction (R). The crossbelt sorter (1) comprises an actuation arrangement (3) adapted selectively to transfer said friction bar (2) between a driving position and a disengaged position, the actuation arrangement (3) having an actuator (31), wherein the actuation arrangement (3) has a connector (33); the actuator (31) is adapted to transfer the connector (33) into an active state.

### CROSS REFERENCE TO RELATED APPLICATIONS

This application is the U.S. national stage of International Application No. PCT/EP2023/076325, filed on 2023 Sep. 25. The international application claims the priority of EP 22198525.2 filed on 2022 Sep. 28; all applications are incorporated by reference herein in their entirety.

### BACKGROUND

The invention refers to a crossbelt sorter.

A generic crossbelt sorter is shown in U.S. Pat. No. 6,273,268 B1 (references in this paragraph refer to that document). The crossbelt sorter comprises a plurality of crossbelt carts which are movable along a conveying direction on a circumferentially closed conveying track. A crossbelt on the crossbelt cart provides a conveying surface for supporting an object to be conveyed. The crossbelt is moveable relative to the crossbelt cart in a traverse direction traverse to the conveying direction. For driving said crossbelt said crossbelt cart has a drive wheel which is adapted to be selectively engaged by a friction bar. Here, the movement of the crossbelt is effected by means of friction bars installed in a fixed location on the travel path, which can be transferred between a driving position and a disengaged position. Resetting springs (FIG. 4, reference sign 40) act on the friction bars into their disengaged position (col. 3, I. 61-67; col. 6, I. 2-6; claim 9). In the driving position the friction bar gets in contact with a drive wheel on the crossbelt cart, resulting in a drive motion of the drive wheel. The drive wheel is connected with the crossbelt, leading to a drive operation of the crossbelt. The actuation of the friction bar into the driving position is performed by an electric or a pneumatic actuator, against the spring forces. Similar crossbelt sorters are shown in DE 20 2012 004 830 U1 and CN 207 061 145 U.

DE 10 2016 104 943 A1 shows a anther sorter of the kind described above. Here a particular belt transmission if provided to transmit the drive force from the drive wheel to the cross-belt.

In the practical implementation (https://www.youtube.com/watch?v=wSoPBGIRIas; 2:34-2:38), a pneumatic actuator is used for this purpose, since the pneumatic actuator has a number of advantages. 1). After actuation into the driving position the pneumatic cylinder remains closed. No energy is needed to keep the actuator and consequently the friction strip in the driving position. 2) When the drive wheel gets in contact with the friction strip, there occurs an impact load between the drive wheel and the strip, which is absorbed by the bearings of the actuator and the drive wheel. The pneumatic pressure within the cylinder serves as a shock absorber and reduces the impact of pressure peaks acting on the actuator, the drive wheel and the bearings. Even inexpensive pneumatic cylinders are sufficiently robust to be able to absorb these pressure peaks without any problems.

However there is in particular a demand to operate a crossbelt sorter without the need of providing any pneumatic infrastructure, so the object of the invention is in particular to provide a crossbelt sorter being operated without pneumatic actuator, thereby maintaining the advantages of the pneumatic actuators.

### SUMMARY

Crossbelt sorter (1), adapted to sort an object (9) into one of a plurality of discharge stations (14);
the crossbelt sorter (1) comprising a plurality of crossbelt carts (11);
the crossbelt carts (11) are movable along a conveying direction (R) on a circumferentially closed conveying track (13);
the crossbelt cart (11) comprising a crossbelt (12);
wherein the crossbelt (12) provides a conveying surface for supporting an object (9) to be conveyed;
the crossbelt (12) is moveable relative to the crossbelt cart (11) in a traverse direction (Q) traverse to the conveying direction (R);
the crossbelt sorter (1) is adapted to transfer said object (9) from the conveying cart (11) selectively into one of the plurality of discharge stations (14) by selectively driving said crossbelt (12) in the traverse direction (Q);
wherein for driving said crossbelt (12) said crossbelt cart (11) has a drive wheel (15) which is adapted to be selectively engaged by a friction bar (2);
said friction bar is stationary located at the track (13);
the crossbelt sorter (1) comprising an actuation arrangement (3) adapted selectively to transfer said friction bar (2) between a driving position and a disengaged position, the actuation arrangement (3) having an actuator (31);
wherein the actuation arrangement (3) having a connector (33);
wherein the actuator (31) is adapted to transfer the connector (33) into an active state,
wherein in the active state the connector (33) urges the friction bar (2) into the drive position.

### DETAILED DESCRIPTION

The invention comprises a crossbelt sorter and a method according to the main claims; embodiments are subject of the subclaims and the description.

The present invention proposes a connector between the actuator and the friction bar. The actuator is provided to transfer the connector into the active state. The actuator then remains in the active state, whereby the actuator is not responsible for keeping the connector in the active state. This enables more freedom in the design and selection of the actuator, since during transferring the object the actuator does not assume any forces operating forces.

In particular the present invention proposes also to replace the commonly widely used pneumatic actuator by an electromagnetic actuator. Thereby the connector provides the advantages which have formerly been provided by the pneumatic mechanism.

As a consequence is in particular decoupled from any loads arising from the interaction between he friction wheel and the friction bar, resulting is increased service life. In particular also the electromagnetic actuator does not need to actively provide a holding force to keep the friction n bar in the driving position.

### BRIEF DESCRIPTION OF THE DRAWINGS

The invention is explained in more detail below with reference to the figures; herein show:

FIG. 1 a crossbelt sorter in top view;

FIG. 2 a sectional view of the crossbelt cart of the crossbelt sorter of FIG. 1 according to the line II-II in FIG. 1.

FIG. 3 to 7 isolated an actuation arrangement 3 of the crossbelt sorter of FIG. 1 in top view during in different situations during a sorting process in a first embodiment;

FIGS. 8 and 9 isolated an actuation arrangement 3 of the crossbelt sorter of FIG. 1 in top and side view during different situations during a sorting process in a second embodiment.

### DETAILED DESCRIPTION OF THE PREFERRED EMBODIMENTS

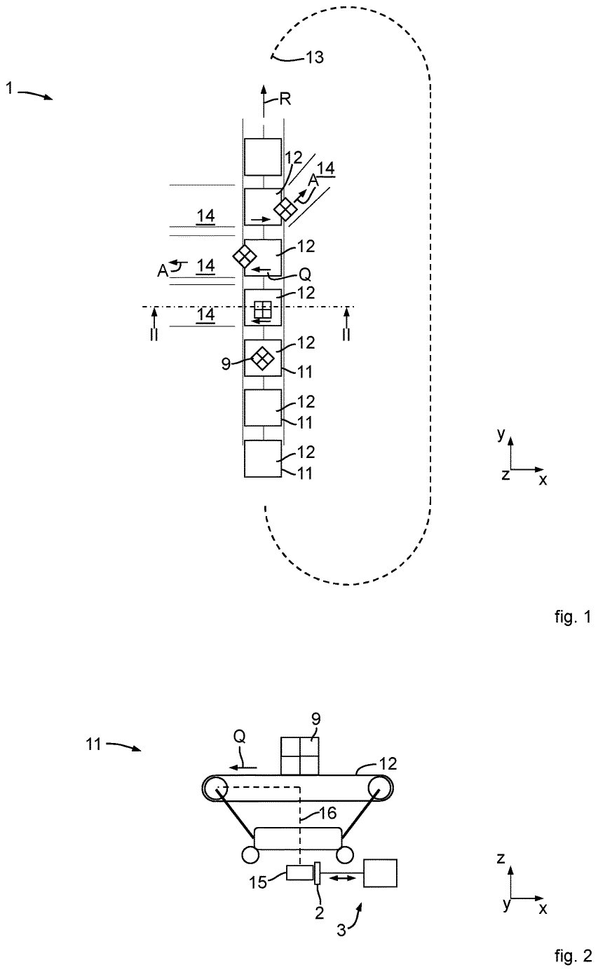

FIG. 1 shows a crossbelt sorter 1. The crossbelt sorter 1 comprises a plurality of crossbelt carts 11, which travel circumferentially in conveying direction R along a closed track 13. On top of each of the carts 11 a crossbelt 12 is provided. A top surface of the crossbelt 12 provides a conveying surface for supporting an object 9 to be conveyed.

A plurality of discharge stations 14 is provided, at which the object 9 can be selectively removed from the crossbelt cart 11 and conveyed to a discharge station 14 provided laterally of the crossbelt cart 11. For this purpose, the crossbelt 12 is set in motion on the crossbelt cart 11 in a direction Q transverse to the conveying direction R.

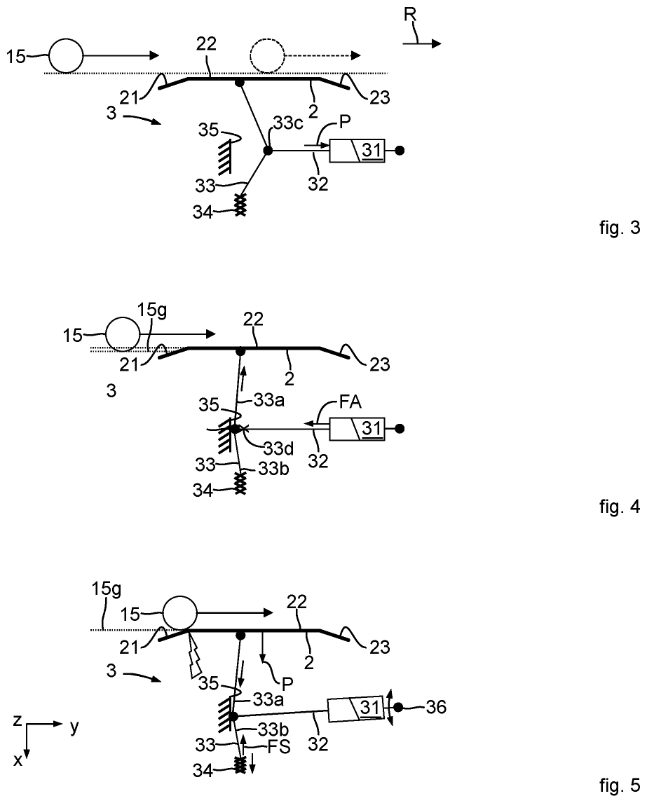

FIG. 2 shows the mechanism for driving the crossbelt 12. Along the track 13 (see FIG. 1) several friction bars 2 are provided which can be transferred between a driving position and a disengaged position.

In the driving position the friction bar 2 gets in frictional contact with a drive wheel 15 on the crossbelt cart 11. Now, due to the relative movement of the drive wheel 15 along the conveying direction R the friction bar 2 sets the drive wheel 15 into rotation.

Via a drive connection 16 (shown merely schematically) the drive wheel 15 is connected to the crossbelt 12, so that a rotation of the drive wheel 15 results in a drive motion of the crossbelt 12 on top of the cart 11 in the transverse direction Q.

In the disengaged position the friction bar 2 is not in frictional contact with the drive wheel 15. No drive power is provided to the crossbelt 12, so that the object 9 keeps its location on top of the crossbelt cart 11.

An actuation arrangement 3 is provided to transfer the friction bar 2 between the driving position and the disengaged position.

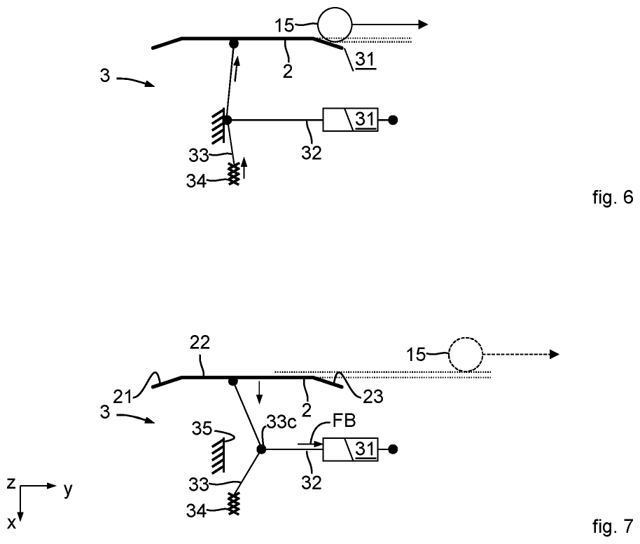

FIG. 3 to 7 show isolated the actuation arrangement 3, the friction bar 2 and the drive wheel 15 in top view in different situations.

The actuation arrangement 3 comprises an electromagnetic actuator 31. In the present example the electromagnetic actuator 31 is a magnet solenoid. As an alternative the electromagnetic actuator 31 may also be a combined rotary drive motor having a transmission for transferring rotational motion of the drive motor into linear movement.

The actuation arrangement 3 comprises a connector 33, connecting the electromagnetic actuator 31 with the friction bar 2. In the present embodiment the connector 33 is a knee lever having two lever arms 33a, 33b, pivotably connected to each other via a knee joint 33c. The electromagnetic actuator 31 moves the connector 33 between an active state and a passive state.

At an opposite end to the knee joint 33c the first lever arm 33a is connected to the friction bar 2. A lateral movement of the first lever arm 33a transfers the friction bar 2 between the driving position and the disengaged position. A movement of the first lever arm 33a in direction away from the knee joint 33c transfers the friction bar 2 from the disengaged position into the driving position. A movement of the first lever arm 33a in direction to the knee joint 33c transfers the friction bar 2 from the driving position into the disengaged position.

At an opposite end to the knee joint 33c the second lever arm 33b is movably supported by a pressure spring 34. The pressure spring 34 is adapted to urge the second lever arm 33b in direction of the knee joint 33c and the direction of the first lever arm 33a.

FIG. 3 shows the actuation arrangement 3 in a passive state and the friction bar 2 in a disengaged position. The electromagnetic actuator 31—here a linear actuator—is connected to the connector 33 by an actuator lever 32 and pulls the knee joint 33c into a position, where a knee angle (angle between the first and second lever arms 33a, 33b) is comparatively small. Consequently also the friction bar 2 is pulled into the disengaged position by the connector 33. With the help of the dotted auxiliary line in FIG. 3 it becomes apparent, that the friction bar 2 is not in frictional contact with the drive wheel 15 of the crossbelt cart, when the cross belt cart is passing the friction bar 2. The pressure spring 34 is in a released state.

FIG. 4 shows the electromagnetic actuator 31 pushing with a first force FA the knee joint 33c into a position, where a knee angle (angle between the first and second lever arms 33a, 33b) is comparatively large. Now the connector 33 is an active state and pushes the friction bar 2 into the driving position.

During transfer from the passive state into the active state, the knee joint 33c passes a death point 33dn (angle between the first and second lever arms 33a, 33b is 180°). When the knee joint 33c is in the death point 33d the first lever arm 33a and the second lever arm 33b are arranged in a 180° orientation. After passing the death point 33d the knee joint 33c faces a stop 35, which limits further movement of the knee joint 33c away from the death point 33d. It is not required that the knee joint 33c contacts the stop 35 in the situation shown in FIG. 4.

In FIG. 4 it is apparent, that the friction bar 2 is in the driving position before the drive wheel 15 passes the friction bar 2. The friction bar 2 protrudes into a drive wheel guideway 15g of the drive wheel 15, thereby waiting for the approaching drive wheel 15. For proper alignment of the friction bar 2 with the drive wheel 15, the friction bar 2 has an upstream ramp 21, where the friction bar 2 initially gets in contact with the drive wheel 15. The upstream ramp 21 is followed by a main section 22 of the friction bar 2.

Afterwards (FIG. 5) the drive wheel 15 hits the friction bar 2 (depicted with the flash). Now the friction bar 2 is abruptly charged by the drive wheel 15 in the direction of the disengaged position (see arrow P). With the first lever arm 33a, the complete knee lever 33 with the second lever arm 33b and the knee joint 33c is moved in direction away of drive wheel guideway 15g.

It becomes apparent from the figure, that this situation does not cause the connector 33 to be moved from the active state into the passive state. Rather, this situation can lead to a solidification of the active state of the connector 33.

Thereby the stop 35 prevents, that the knee angle significantly changes. Finally the abrupt charge of the friction bar 2 is absorbed by the pressure spring 34, which gets tensioned. The pressure spring 34 now maintains an actuating force FS pressing the friction bar 2 into the driving position and consequently into a frictional engagement with the drive wheel 15.

As a consequence the electromagnetic actuator 31 does not provide any force to keep the connector 33 in the active state. As a further consequence there is no energy supply required to keep the friction bar 2 in the driving position.

Starting from the situation shown in FIG. 5, in the further course the drive wheel 15 rolls along the friction bar 2, thereby driving the crossbelt 12 via the drive connection 16 (see FIG. 2).

In the present example the electromagnetic actuator 31 serves for transferring the connector 33 into the active state where the pressure spring 34 (not the actuator 33) maintains an actuating force FS acting on the friction bar 2 as can be seen in FIG. 5. In the active state the connector 33 is in a self-locking position. The electromagnetic actuator 31 is decoupled from any loads caused by the abrupt urging of the friction bar 2. The electromagnetic actuator 31 is tilted merely slightly, which can be absorbed with a pivotable support 36. Instead of that the support 36 is pivotable, the actuator lever 32 can comprise a hinge (not shown).

In FIG. 6 the drive wheel 15 has left the friction bar 2, so that the friction bar 2 can slightly move further the drive position as in FIG. 4. In a next step (FIG. 7) the electromagnetic actuator 31 pulls the knee lever 33 with a second force FB back into the disengaged position as of FIG. 3. Now the method can be repeated.

It is also to be noted that other areas of the knee lever 33 than the knee joint may abut at the stop 35, e.g. an explicit counter stop may be provided on any of the two lever arms 33a, 33b.

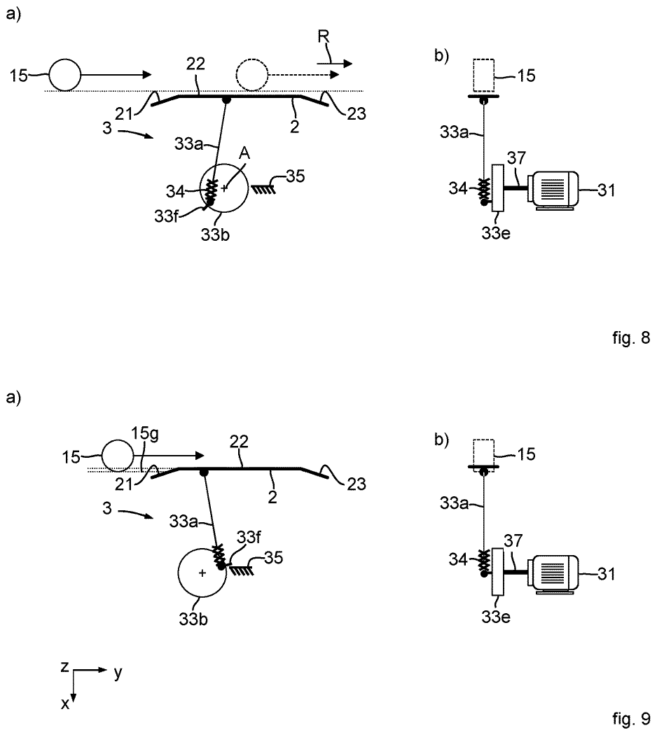

FIGS. 8 and 9 show another embodiment of the actuation arrangement 3. Here the electromagnetic actuator 31 is an electromotor having a rotating drive shaft 37.

Instead of a knee joint 33c the connector 33 comprises an eccentric disc 33e. At a radial distance to an axis of rotation A of the eccentric disc 33e the first lever arm 33a is connected.

FIG. 8 shows the connector 33 in a passive state and the friction bar 2 is in the disengaged position.

For transferring the connector 33 in the active state the electromotor 31 turns the eccentric disc 33e in the position as shown in FIG. 9. Here an abutment 33f of the eccentric disc 33e can engage with a rotational stop 35 to prevent further movement of the eccentric disc 33e

The eccentric disc 33e is supported in a radial direction by a sufficiently dimensioned bearing (not shown) to absorb the radial forces acting during the operation.

A pressure spring 34 is arranged anywhere in the path of force between the stop 35 and the friction bar 2. In the shown embodiment the pressure spring 34 is located between the first lever arm 33a and the eccentric disc 33e. In another embodiment the pressure spring 34 is arranged between the first lever arm 33a and the friction bar 2. In still another embodiment the pressure spring 34 is arranged between the The mode of operation corresponds widely to the embodiment shown in FIG. 3 to 7. Also in the present embodiment when friction bar 2 may be abruptly charged by the drive wheel 15 in the direction of the disengaged position. The first lever arm 33a is moved in direction away from the drive wheel guideway 15g and pushes the abutment 33f against the stop 35, keeping the connector 33 in the active state. The electric motor 31 is passive and provides no force.

### LIST OF REFERENCE NUMERALS

1 crossbelt sorter
2 friction bar
3 actuation arrangement
9 object to be conveyed
11 crossbelt cart
12 crossbelt
13 track
14 discharge station
15 drive wheel
15g drive wheel guideway
16 drive connection
21 upstream ramp
22 main section
31 electromagnetic actuator/electric motor
32 actuator lever
33 connector/knee lever
33a first lever arm
33b second lever arm
33c knee joint
33d death point
33e eccentric disc
33f abutment
34 pressure spring
35 stop
36 pivotable support
A axis of rotation
FS actuating force
FA first force
FB second force
Q traverse direction
R conveying direction

1. Crossbelt sorter (1), adapted to sort an object (9) into one of a plurality of discharge stations (14);
the crossbelt sorter (1) comprising a plurality of crossbelt carts (11);
the crossbelt carts (11) are movable along a conveying direction (R) on a circumferentially closed conveying track (13);
the crossbelt cart (11) comprising a crossbelt (12);
wherein the crossbelt (12) provides a conveying surface for supporting an object to be conveyed;
the crossbelt (12) is moveable relative to the crossbelt cart (11) in a traverse direction (Q) traverse to the conveying direction (R);
the crossbelt sorter (1) is adapted to transfer said object (9) from the conveying cart (11) selectively into one of the plurality of discharge stations (14) by selectively driving said crossbelt (12) in the traverse direction (Q);
wherein for driving said crossbelt (12) said crossbelt cart (11) has a drive wheel (15) which is adapted to be selectively engaged by a friction bar (2);
said friction bar is stationary located at the track (13);
the crossbelt sorter (1) comprising an actuation arrangement (3) adapted to selectively transfer said friction bar (2) between a driving position and a disengaged position;
the actuation arrangement (3) having an, in particular electromagnetic, actuator (31);
characterized in
that the actuation arrangement (3) having a connector (33);
wherein the actuator (31) is adapted to transfer the connector (33) into an active state,
wherein in the active state the connector (33) urges the friction bar (2) into the drive position.

2. Crossbelt sorter (1) according to claim 1,
characterized in
that the actuator (31) is adapted to transfer the connector (33) into a passive state, wherein in the passive state the connector (33) does not urge the friction bar (2) into the drive position.

3. Crossbelt sorter (1) according to claim 1,
characterized by
a pressure spring (34) adapted to provide an actuating force (FS) to the connector (33) for urging the friction bar (2) into the drive position, when the connector (33) is in the active state.

4. Crossbelt sorter (1) according to claim 3,
characterized in
that in the active state the connector (33) is in a self-locking position maintaining the active state.

5. Crossbelt sorter (1) according to claim 1,
characterized in
that the actuation arrangement (3) is adapted to keep the connector (33) in the active state without requiring a force provided by the actuator (31).

6. Crossbelt sorter (1) according to claim 1,
characterized in
that in the drive position a drive wheel (15) passing said friction bar (2) contacts the friction bar (2), and
that in the disengaged position said drive wheel (15) passing said friction bar (2) is not contacting said friction bar (2).

7. Crossbelt sorter (1) according to claim 1,
characterized by
a stop (35),
the stop (35) is adapted to keep the connector (33) in the active state in case the connector (33) is urged by the friction bar (2) in a direction away from the friction bar (2).

8. Crossbelt sorter (1) according to claim 1,
wherein the stop (35) is separate to the actuator (31).

9. Method operating a crossbelt sorter (1) according to claim 1,
comprising the steps of
transferring the friction bar (2) into said driving position, thereby transferring the connector (33) into an active state by providing an first force (FA) by said actuator (31),
afterwards maintaining the connector (33) in said active state, without providing a holding force by said actuator (31).

10. Method according to claim 9,
transferring the friction bar (2) out of said driving position, thereby
transferring the connector (33) into an inactive state by providing an second force (FB) by said actuator (31), wherein the second force is (FB) in contrary direction to the first force (FA).
